(19) United States
(12) Patent Application Publication
(10) Pub. No.: US 2019/0186151 A1
(43) Pub. Date: Jun. 20, 2019

(54) Attic Ladder and Kit

(71) Applicant: Bernabe Canlas, League City, TX (US)

(72) Inventor: Bernabe Canlas, League City, TX (US)

(21) Appl. No.: 16/215,844

(22) Filed: Dec. 11, 2018

Related U.S. Application Data
(60) Provisional application No. 62/598,756, filed on Dec. 14, 2017.

(51) Int. Cl. E04F 11/06; E06C 7/12

(52) U.S. Cl. CPC E04F 11/064; E06C 7/12

(57) ABSTRACT

An attic ladder modification kit, a method of modifying an attic ladder using the kit, an attic ladder, and a method of using the attic ladder. The attic ladder modification kit includes a plurality of components for installation onto the attic ladder to improve the safety and ease of use of the attic ladder through modification, either during construction of the attic ladder, or as an after-market addition to the attic ladder. The plurality of components includes a pair of springs to bias a hinged connection between a middle section and an upper section of the attic ladder, means to removably secure a lower section hingedly connected to the middle section of the attic ladder, and a rope and pulley system and a descent rope to facilitate raising and lowering the attic ladder into and out of an attic opening, respectively.

### CROSS REFERENCE TO RELATED APPLICATIONS

This application claims priority under 35 U.S.C. § 119(e) to U.S. Provisional Application No. 62/598,756 filed on Dec. 14, 2017. The above identified patent application is incorporated by reference herein in its entirety to provide continuity of disclosure.

### BACKGROUND OF THE INVENTION

The present invention relates to an attic ladder modification kit, a method of modifying an attic ladder using the kit, an attic ladder, and a method of using the attic ladder. The invention provides kits, devices, and methods for improving the safety, ease of use, and utility of attic ladders.

Attics are disposed above a primary space of a domicile or other structure, and often require ascension through an attic door to gain access. Ascension is often performed by climbing a ladder, and many attic doors include an attic ladder attached to a cover of the attic door intended for this purpose. While these attic ladders are sometimes sufficient, they are rarely satisfactory, and accessing attics with these attic ladders is often a difficult or dangerous undertaking. The attic ladder is difficult to pull down from a closed position, and even when this is accomplished, the attic ladder is difficult to control due to the weight of the ladder and the tendency of the attic ladder to unfold unexpectedly, which can endanger one or more individuals, animals, or valuables nearby. Because attics may not be accessed regularly, familiarity with the difficulties and dangers of opening attic doors and using attic ladders may not be strong enough to prevent injury or damage. A safer and more controlled attic ladder for accessing attics may enable an increase in the frequency of access, thereby improving a quality of use of these spaces.

Therefore, there is a need in the art for an improved attic ladder. The present invention addresses this unmet need.

Devices have been disclosed in the art that relate to attic ladders. These include devices that have been patented and published in patent application publications. These devices are often heavy, awkward, and dangerous to use. In view of the devices disclosed in the art, it is submitted that there is a need in the art for an improvement to existing attic ladders. In view of the present disclosure, it is submitted that the present invention substantially diverges in structural and functional elements from devices in the art, and substantially fulfills an unmet need in the art.

### SUMMARY OF THE INVENTION

In view of the disadvantages inherent in the known types of attic ladders in the art, the present invention provides a new and improved attic ladder, wherein the same can be utilized for safely accessing an attic.

It is therefore an object of the present invention to provide an improved attic ladder for increasing safety. It is another object of the present invention to provide an attic ladder modification kit, which can be installed onto a new or an existing attic ladder to improve the safety thereof. It is another object of the present invention to provide a method of modifying an attic ladder using the kit, as well as a method of using the modified or improved attic ladder.

In one aspect, the invention provides an attic ladder modification kit, comprising a first spring configured to bias any connection between any two sections of an attic ladder. The kit further includes a pulley system configured to transition the attic ladder between a first position and a second position, and a fastener to controllably secure one or more sections of the attic ladder. In some embodiments, the kit includes a descent rope for initiating and controllably transitioning the attic ladder between the first position and the second position.

In another aspect, the invention provides an attic ladder, comprising an upper section, a middle section, and a lower section. The upper section is pivotally connected to the middle section, and the middle section is pivotally connected to the lower section. The attic ladder includes a first spring configured to bias any connection between any two sections of the attic ladder, a pulley system configured to transition the attic ladder between a first position and a second position, and a fastener to controllably secure one or more sections of the attic ladder. In some embodiments, the kit includes a descent rope for initiating and controllably transitioning the attic ladder between the first position and the second position.

Another object of the present invention is to provide an improved attic ladder, and a kit for manufacturing the improved attic ladder, each of which may be readily manufactured from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of the invention will be particularly pointed out in the claims, the invention itself and manners in which it may be made and used may be better understood after a review of the following description, taken in connection with the accompanying drawings, wherein like numeral annotations are provided throughout.

FIG. 1 depicts a front left perspective view of an exemplary improved attic ladder, shown in an extended configuration, wherein components of the modification kit are installed onto an attic ladder.

FIG. 2 depicts a left perspective view of the improved attic ladder, shown in a retracted configuration.

FIG. 3 depicts a close-up perspective view of an exemplary fastener to controllably secure a lower section of the improved attic ladder to a middle section of the improved attic ladder in a folded configuration.

FIG. 4 depicts a close-up perspective view of an exemplary first spring and second spring of the invention, configured to bias a pivotal connection between the middle section of the improved attic ladder and an upper section of the improved attic ladder.

FIG. 5 depicts a close-up perspective view of an exemplary pulley system of the invention, configured to provide leverage to facilitate use of the improved attic ladder and improve the safety thereof.

### DETAILED DESCRIPTION OF THE INVENTION

Reference is made herein to the attached drawings. Like reference numerals are used throughout the drawings to depict like or similar elements of the invention. The figures are intended for representative purposes only and should not be considered limiting in any respect.

Reference is now made to the drawings, which depict one or more exemplary embodiments of the invention.

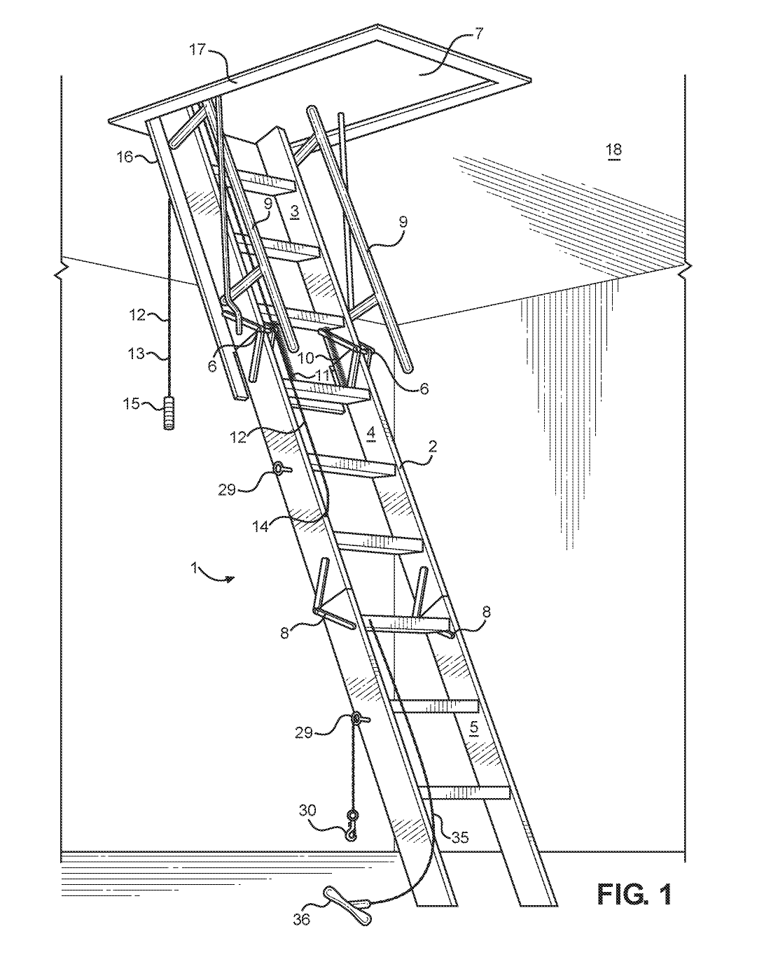

Referring now to FIG. 1, there is depicted a front left perspective view of an exemplary improved attic ladder, shown in an extended configuration, wherein components of the modification kit are installed onto an attic ladder. An improved attic ladder 1 may be made by modifying an attic ladder 2 using a kit of the present invention. The attic ladder 2 includes an upper section 3, a middle section 4, and a lower section 5. The upper section 3 is pivotally connected to the middle section 4, and the middle section 4 is pivotally connected to the lower section 5. A pivotal connection between the upper section 3 and the middle section 4 is oriented such that the middle section 4 pivots forward and upward about an axis (e.g., hinges 6) therebetween, toward a forward portion of an attic opening 7 above. A pivotal connection between the middle section 4 and the lower section 5 is oriented such that the lower section 5 pivots backward and upward about an axis (e.g., hinges 8) therebetween, toward a rearward portion of the attic opening 7 above. In this manner, the attic ladder 2 is foldable into a more compact shape, to fit inside a space of an attic above the attic opening 7. The attic ladder 2 includes hand rails 9, sized and configured to stabilize an individual navigating the attic ladder 2 to increase the safety of the attic ladder 2 and the improved attic ladder 1.

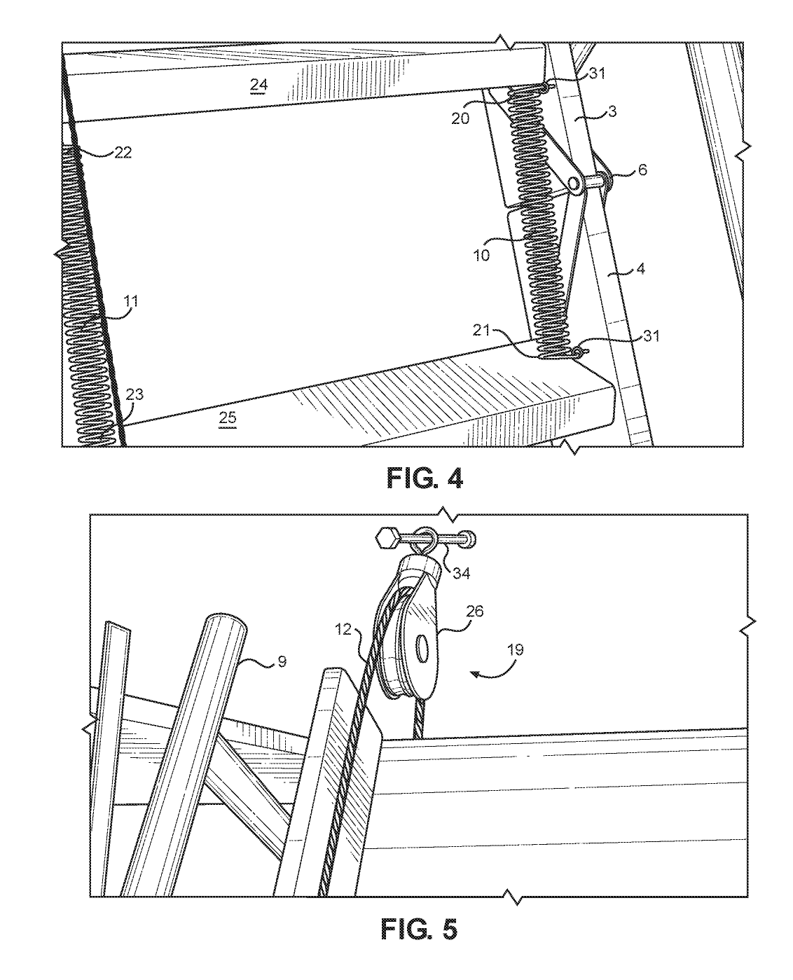

Referring now to FIGS. 1 and 4, there are depicted a front left perspective view of an exemplary improved attic ladder, shown in an extended configuration, wherein components of the modification kit are installed onto an attic ladder (FIG. 1) and a close-up perspective view of an exemplary first spring and second spring of the invention, configured to bias a pivotal connection between the middle section of the improved attic ladder and an upper section of the improved attic ladder (FIG. 4). In the shown embodiment, an attic ladder modification kit includes a first spring 10 configured to bias the pivotal connection between the upper section 3 and the middle section 4. In the shown embodiment, the attic ladder modification kit also includes a second spring 11, also configured to bias the pivotal connection between the upper section 3 and the middle section 4.

In the shown embodiment, each of the first spring 10 and the second spring 11 is attached on an upper end (20, 22) thereof to the upper section 3, and on a lower end (21, 23) thereof to the middle section 4. In the shown embodiment, each of the first spring 10 and the second spring 11 is attached on the upper end (20, 22) thereof to an eyebolt 31 adjacent to a rung 24 of the upper section 3, and each of the first spring 10 and the second spring 11 is attached on the lower end (21, 23) thereof to an eyebolt 31 adjacent to a rung 25 of the middle section 4 (FIG. 4). In this manner, the first spring 10 and the second spring 11 are configured to bias the pivotal connection (i.e., having hinges 6) between the upper section 3 and the middle section 4 toward the extended position (as shown in FIG. 1). The improved attic ladder 1 also includes a pulley system 19, as described elsewhere herein, to enable an individual to control a descent of the improved attic ladder 1 down from the attic opening 7 above, toward a floor below, as part of a method of using the improved attic ladder 1, also described elsewhere herein. In this manner, the improved attic ladder 1 does not readily or uncontrollably fall down onto the individual using the improved attic ladder 1, or another individual or item below the improved attic ladder 1, thereby greatly increasing the safety of the attic ladder 2 through these additions or modifications.

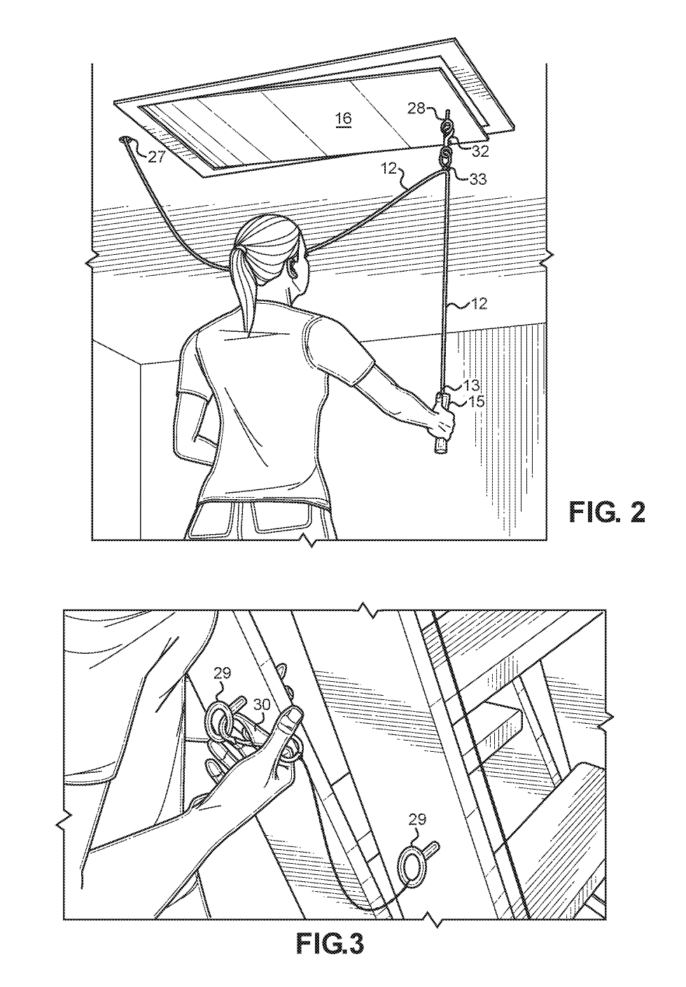

Referring now to FIGS. 1, 2, and 5, there are depicted a front left perspective view of an exemplary improved attic ladder, shown in an extended configuration, wherein components of the modification kit are installed onto an attic ladder (FIG. 1), a left perspective view of the improved attic ladder, shown in a retracted configuration (FIG. 2), and a close-up perspective view of an exemplary pulley system of the invention, configured to provide leverage to facilitate use of the improved attic ladder (FIG. 5). In the shown embodiment, the attic ladder modification kit also includes a pulley system 19 configured to work alone or in combination with a descent rope 35 and/or one or more springs (10, 11) of the invention to enable the individual to controllably transition the improved attic ladder 1 between a first position (e.g., upward, folded, retracted) and a second position (e.g., downward, unfolded, extended). In the shown embodiment, the descent rope 35 is attached to a top rung of the lower section 5 and includes a handle 36 on a distal end thereof. In this manner, an individual transitioning the improved attic ladder 1 from a closed or retracted position to an open or extended position can controllably pull on the descent rope 35 while controllably releasing a first end 13 of a rope 12 of the pulley system 19, thereby improving stability and safety of the descent of the improved attic ladder 1. Similarly, to achieve better control of the descent of the improved attic ladder 1, in some embodiments the first end 13 of the rope 12 includes a snap hook 32 thereon.

In the shown embodiment, the pulley 26 of the pulley system 19 is positioned above the upper section 3, and is secured in place by a lag bolt 34, which is secured to a stable structure above the pulley 26. The first end 13 of the rope 12 of the pulley system 19 is positioned behind a rearward face of the improved attic ladder 1, and a second end 14 of the rope 12 of the pulley system 19 is positioned afore (i.e., in front of) a forward face of the improved attic ladder 1. In the shown embodiment, a portion of the rope 12 of the pulley system 19 positioned between the pulley 26 and the first end 13 of the rope 12 of the pulley system 19 is slidably disposed through a hole 27 placed in a portion of the ceiling 18 adjacent to the improved attic ladder 1 (see FIG. 2). To enable the individual to control a transition of the improved attic ladder 1 between two positions, a portion (e.g., a portion positioned at or near the second end 14) of the rope of the pulley system 19 is attached to a lower portion of the middle section 4 of the improved attic ladder 1. In the shown embodiment, the first end 13 of the rope 12 includes a hand grip 15 thereon.

If the improved attic ladder 1 is in the upward or folded position, the individual can grip the first end 13 or the hand grip 15 and pull down to open a cover 16 of the attic opening 7 by controllably lowering the cover 16 such that it pivots about a connection to a frame 17 and/or a ceiling 18 or other component nearby (e.g., a hinge connecting the cover 16 to the frame 17 and/or the ceiling 18). To maximize a leverage on the connection to the frame 17 and/or the ceiling 18 nearby, an eyebolt 28 (or alternatively, a hook or other suitable structure) is attached to the cover 16, to which a snap hook 32 affixed to the rope 12 by a knot 33 is connected (see FIG. 2). From this or a similar position or configuration, the snap hook 32 is disengaged from the eyebolt 28, and in this manner, the pulley system 19 may be used. At this point, the individual can grasp the handle 36 of the descent rope 35 and pull down on the descent rope 35, while controllably releasing the hand grip 15, to unfold the lower and middle sections (collectively; 4 and 5) from the upper section 3, through a coordinated action of both the rope 12 and pulley system 19, as well as the descent rope 35. During this movement, the bias of one or more of the springs (10, 11) counters the force of gravity at the pivotal connection between the upper section 3 and the middle section 4, allowing the improved attic ladder 1 to unfold in a controlled manner. In this manner, the individual can control the descent of the improved attic ladder 1 toward the downward or extended position.

The pulley system 19 may also be utilized to place the improved attic ladder 1 from the downward or extended position to the upward or retracted position. This may be accomplished by pulling downward on the first end 13 or the hand grip 15, which causes the rope 12 of the pulley system 19 to pull upward on the lower portion of the middle section 4 to which the portion of the rope 12 is attached, which raises the middle section 4 and the attached lower section 5, by causing the middle section 4 to pivot about its connection with the upper section 3 (e.g., having hinges 6), engaging the bias of one or more of the springs (10, 11).

Referring now to FIGS. 1 and 3, there are depicted a front left perspective view of an exemplary improved attic ladder, shown in an extended configuration, wherein components of the modification kit are installed onto an attic ladder (FIG. 1) and a close-up perspective view of an exemplary fastener to controllably secure a lower section of the improved attic ladder to a middle section of the improved attic ladder in a folded configuration (FIG. 3). If the improved attic ladder 1 is in the downward or extended configuration, the lower section 5 may be folded to interface with the middle section 4 before or during folding the middle section 4 to interface with the upper section 3. To prevent the lower section 5 from uncontrollably pivoting during transition of the improved attic ladder between positions, the attic ladder modification kit may also include a fastener to controllably secure the lower section 5 to the middle section 4 in a folded configuration. Generally, the fastener includes one or more connections to controllably secure the pivotal connection between the lower section 5 and the middle section 4. In the shown embodiment, the fastener includes a pair of eyebolts 29 connectable (FIG. 1) and connected (FIG. 3) by a snap hook 30. In this manner, the snap hook 30 can easily be engaged or disengaged to facilitate storage or use of the improved attic ladder, respectively. Alternate exemplary fasteners to controllably secure the lower section 5 and the middle section 4 in the folded configuration include, but are not limited to, a snap hook, a clasp, a strap, an adjustable strap, a hook-and-loop interaction, a magnetic interaction, or a combination, variation, or alternative thereof.

Reference is now made to FIGS. 1-5. Installation of components of the kit of the present invention to the attic ladder 2 may be performed before or after installation of the attic ladder 2 into a building or structure. The springs (10, 11) may be attached to the attic ladder 2 at positions adjacent the rungs (e.g., below rung 24, above rung 25) via a suitable fastener, such as an eyebolt (FIG. 4). The lower section 5 may be secured to the middle section 4 via a suitable fastener, such as the snap hook 30 with eyebolts 29 (FIG. 3), a snap hook, a clasp, a strap, an adjustable strap, a hook-and-loop interaction, a magnetic interaction, or a combination or alternative thereof. In this manner, the lower section 5 does not uncontrollably swing about, which would increase a risk of injury or damage to an individual or object. The pulley system 19 may be attached, by way of the lag bolt 34 or another suitable fastener, to a ceiling header or ceiling beam, or other solid structure, positioned in the attic, so as to provide sufficient support for bearing the forces generated during use. The first end 13 of the rope 12 is fed through the hole 27 in the ceiling 18, which may be positioned below the pulley 26 of the pulley system 19. In this manner, a frictional force between the rope 12 and the ceiling 18 may be minimized. Accordingly, an eyelet may also be disposed in the hole 27, to reduce or eliminate an interaction between the rope 12 and the ceiling 18, thereby preserving the structural integrity of the ceiling 18 and/or the rope 12.

The foregoing descriptions of specific embodiments of the present invention have been presented for purposes of illustration and description. They are not intended to be exhaustive or to limit the present invention to the precise forms disclosed, and modifications and variations are possible in view of the above teaching. The exemplary embodiment was chosen and described to best explain the principles of the present invention and its practical application, to thereby enable others skilled in the art to best utilize the present invention and its embodiments with modifications as suited to the use contemplated.

It is therefore submitted that the present invention has been shown and described in the most practical and exemplary embodiments. It should be recognized that departures may be made which fall within the scope of the invention. With respect to the description provided herein, it is submitted that the optimal features of the invention include variations in size, materials, shape, form, function and manner of operation, assembly, and use. All structures, functions, and relationships equivalent or essentially equivalent to those disclosed are intended to be encompassed by the present invention.

I claim:

1. An attic ladder modification kit, comprising:
a first spring configured to bias a connection between two sections of an attic ladder;
a pulley system configured to transition the attic ladder between a first position and a second position; and
a fastener configured to secure one or more sections of the attic ladder.

2. The attic ladder modification kit of claim 1, further comprising a descent rope attachable to a top rung of a lower section of the attic ladder.

3. The attic ladder modification kit of claim 1, further comprising a snap hook that is securable to a first end of a rope of the pulley system, wherein the snap hook is near a ceiling if the ladder assembly is in a downward or extended position.

4. The attic ladder modification kit of claim 1, wherein the first spring is attached on an upper end thereof to an upper section of the attic ladder, and on a lower end thereof to a middle section of the attic ladder, wherein a connection between the upper section and the middle section is pivotal.

5. The attic ladder modification kit of claim 4, further comprising a second spring, wherein the second spring is attached on an upper end thereof to the upper section of the attic ladder, and on a lower end thereof to the middle section of the attic ladder.

6. The attic ladder modification kit of claim 5, wherein each of the first spring and the second spring is attached on the upper end thereof to a fastener adjacent to a rung of the upper section of the attic ladder, wherein each of the first spring and the second spring is attached on the lower end thereof to a fastener adjacent to a rung of the middle section of the attic ladder.

7. The attic ladder modification kit of claim 1, wherein a pulley of the pulley system is positioned above an upper section of the attic ladder, wherein a first end of a rope of the pulley system is positioned behind a rearward face of the attic ladder, wherein a second end of the rope of the pulley system is positioned afore a forward face of the attic ladder.

8. The attic ladder modification kit of claim 7, wherein a portion of the rope of the pulley system is attached to a middle section of the attic ladder.

9. The attic ladder modification kit of claim 8, wherein a portion of the rope of the pulley system positioned between the pulley and the first end of the rope of the pulley system is slidably disposed through a hole in a ceiling adjacent to the attic ladder.

10. The attic ladder modification kit of claim 1, wherein the fastener configured to secure one or more sections of the attic ladder includes one or more connections to secure a pivotal connection between a lower section of the attic ladder and a middle section of the attic ladder.

11. The attic ladder modification kit of claim 10, wherein the fastener configured to secure the pivotal connection between the lower section of the attic ladder and the middle section of the attic ladder is configured to secure the lower section and the middle section in a folded configuration.

12. The attic ladder modification kit of claim 11, wherein the fastener configured to secure the lower section and the middle section in a folded configuration includes at least one fastener selected from a group consisting of: a snap hook, a clasp, a strap, an adjustable strap, a hook-and-loop interaction, a magnetic interaction, and a combination thereof.

13. An attic ladder, comprising:
an upper section, a middle section, and a lower section, wherein the upper section is pivotally connected to the middle section, wherein the middle section is pivotally connected to the lower section;
a first spring configured to bias any connection between any two sections of the attic ladder;
a pulley system configured to transition the attic ladder between a first position and a second position; and
a fastener configured to secure one or more sections of the attic ladder.

14. The attic ladder of claim 13, further comprising a descent rope attached to a top rung of the lower section of the attic ladder.

15. The attic ladder of claim 13, further comprising a snap hook that is secured to a first end of a rope of the pulley system, wherein the snap hook is near a ceiling if the ladder assembly is in a downward or extended position.

16. The attic ladder of claim 13, wherein the first spring is attached on an upper end thereof to the upper section of the attic ladder, and on a lower end thereof to the middle section of the attic ladder.

17. The attic ladder of claim 16, further comprising a second spring, wherein the second spring is attached on an upper end thereof to the upper section of the attic ladder, and on a lower end thereof to the middle section of the attic ladder.

18. The attic ladder of claim 17, wherein each of the first spring and the second spring is attached on the upper end thereof to a fastener adjacent to a rung of the upper section of the attic ladder, wherein each of the first spring and the second spring is attached on the lower end thereof to a fastener adjacent to a rung of the middle section of the attic ladder.

19. The attic ladder of claim 13, wherein a pulley of the pulley system is positioned above the upper section of the attic ladder, wherein a first end of a rope of the pulley system is positioned behind a rearward face of the attic ladder, wherein a second end of the rope of the pulley system is positioned afore a forward face of the attic ladder.

20. The attic ladder of claim 19, wherein a portion of the rope of the pulley system is attached to the middle section of the attic ladder.

21. The attic ladder of claim 20, wherein a portion of the rope of the pulley system positioned between the pulley and the first end of the rope of the pulley system is slidably disposed through a hole in a ceiling adjacent to the attic ladder.

22. The attic ladder of claim 13, wherein the fastener configured to secure one or more sections of the attic ladder includes one or more connections to secure the pivotal connection between the lower section of the attic ladder and the middle section of the attic ladder.

23. The attic ladder of claim 22, wherein the fastener configured to secure the pivotal connection between the lower section of the attic ladder and the middle section of the attic ladder is configured to secure the lower section and the middle section in a folded configuration.

24. The attic ladder of claim 23, wherein the fastener configured to secure the lower section and the middle section in a folded configuration includes at least one fastener selected from a group consisting of: a snap hook, a clasp, a strap, an adjustable strap, a hook-and-loop interaction, a magnetic interaction, and a combination thereof.
